(19) United States
(12) Patent Application Publication
(10) Pub. No.: US 2022/0085387 A1
(43) Pub. Date: Mar. 17, 2022

(54) OXYGEN CATALYST AND ELECTRODE USING SAID OXYGEN CATALYST

(71) Applicant: THE DOSHISHA, Kyoto (JP)

(72) Inventor: Masatsugu MORIMITSU, Kyoto (JP)

(21) Appl. No.: 17/424,670

(22) PCT Filed: Jan. 22, 2020
(86) PCT No.: PCT/JP2020/002124

§ 371 Date: Jul. 21, 2021

(30) Foreign Application Priority Data
Jan. 23, 2019 (JP) 2019-009461

(51) Int. Cl. H01M 4/90; C25B 11/077; C01G 55/00

(52) U.S. Cl. CPC H01M 4/9016; H01M 2004/8689; C01G 55/002; C25B 11/077

(57) ABSTRACT

Provided are: an oxygen catalyst that uses an alkaline aqueous solution as an electrolyte and has high catalytic activity; and an electrode. The oxygen catalyst according to the present invention is an oxygen catalyst in which an alkaline aqueous solution is used as an electrolyte, the oxygen catalyst being characterized by having a pyrochlore oxide structure including bismuth on an A-site and ruthenium on a B-site, and containing manganese as well as bismuth and ruthenium. The electrode according to the present invention is characterized by using the oxygen catalyst according to the present invention.

### CROSS REFERENCE TO RELATED APPLICATIONS

This application is a national stage application, filed under 35 U.S.C. § 371, of International Application No. PCT/JP2020/002124, filed Jan. 22, 2020, which claims priority to Japan Application No. 2019-009461, filed Jan. 23, 2019, the contents of both of which as are hereby incorporated by reference in their entirety.

### BACKGROUND

### Technical Field

The present invention relates to oxygen catalysts that use an alkaline aqueous solution as an electrolyte and that are used for a reduction reaction in which oxygen is reduced to produce hydroxide ions and/or an oxidation reaction in which hydroxide ions are oxidized to produce oxygen, and electrodes using the oxygen catalyst.

### Description of Related Art

An oxygen catalyst has a catalytic action for oxygen reduction or oxygen generation or both. For example, for air batteries using an alkaline aqueous solution such as lithium hydroxide aqueous solution, potassium hydroxide aqueous solution, or sodium hydroxide aqueous solution as an electrolyte, the following reactions, namely oxygen reduction in which hydroxide ions (OH⁻) are produced in the alkaline aqueous solution and oxygen generation in which hydroxide ions in the alkaline aqueous solution are oxidized, are known.

Reduction:O₂+2H₂O+4e⁻→4OH⁻ (Chemical formula 1)

Oxidation:4OH⁻→O₂+2H₂O+4e⁻ (Chemical formula 2)

These reactions occur at the anode of the air battery. In an air primary battery, the reduction reaction of Chemical formula 1 occurs during discharge. In an air secondary battery, the reaction of Chemical formula 1 occurs during discharge as in the air primary battery, and the oxidation reaction of Chemical formula 2 occurs during charging. The air battery has its name because it can use oxygen in air for discharge. The positive electrode of the air battery is also called an air electrode for the same reason. However, oxygen used in the reaction of Chemical formula 1 does not have to be oxygen in air. The oxygen reduction reaction that occurs at the air electrode of the air battery using such an alkaline aqueous solution as described above is the same as the oxygen reduction reaction that occurs at an oxygen cathode for brine electrolysis for producing caustic soda and chlorine by electrolyzing the alkaline aqueous solution. The same oxygen catalyst can therefore be used for the air electrode of the air battery and the oxygen cathode for the brine electrolysis. The reaction that occurs at the cathode of an alkaline fuel cell during power generation is also the same oxygen reduction. The same oxygen catalyst can therefore be used for the air electrode of the air battery, the oxygen cathode for the brine electrolysis, and the cathode of the alkaline fuel cell. Moreover, the reaction (Chemical formula 2) that occurs at the air electrode of the air secondary battery during charging is an oxygen generation reaction that occurs at the anode for alkaline water electrolysis. The same oxygen catalyst can therefore be used for the air electrode of the air secondary battery and the anode for the alkaline water electrolysis.

All of the air battery, brine electrolysis, alkaline fuel cell, and alkaline water electrolysis described above use an alkaline aqueous solution as an electrolyte, and the operating temperature of the electrolyte is from room temperature to around 90° C. That is, an oxygen reaction using an alkaline aqueous solution as an electrolyte is an oxidation reaction or reduction reaction that occurs between oxygen and hydroxide ions in such a temperature range, and the oxygen catalyst of the present invention is a catalyst for these reactions. There are also other electrochemical reactions that reduce oxygen or generates oxygen. For example, the reaction that occurs at the cathode of a solid oxide fuel cell (SOFC) is a reduction reaction from oxygen to oxide ions (O²⁻), and the reaction that occurs at the anode of a solid oxide water electrolyzer is an oxidation reaction from oxide ions to oxygen.

Both of these reactions are reactions at high temperatures from around 600° C. to around 1000° C. As described above, the reaction mechanism of the reaction of oxygen is different depending on the temperature, and a suitable oxygen catalyst is therefore also different depending on the reaction mechanism. Accordingly, the operating mechanism of the catalyst is significantly different depending on the reaction mechanism. Not only the activity of the oxygen catalyst but also the stability thereof vary significantly depending on the reaction mechanism. Accordingly, for example, even if a certain catalyst is found to have high activity at temperatures as high as 600° C., it does not mean that that catalyst also has high catalytic activity at 100° C. or less. It is very difficult even for those skilled in the art to infer or presume this fact. It is also difficult for the catalyst for electrochemical reactions to exhibit higher activity at low temperatures such as, e.g., near room temperature than at high temperatures, and it is difficult to find a catalyst that has higher activity as the temperature used decreases.

Regarding air primary batteries using an alkaline aqueous solution as an electrolyte, zinc-air primary batteries using zinc as a negative electrode have been put into practical use as the power source for hearing aids, and similar air primary batteries using a metal other than zinc, such as magnesium, calcium, aluminum, or iron, as a negative electrode are being developed. Regarding air secondary batteries using an alkaline aqueous solution as an electrolyte, no air secondary batteries have been put into practical use except for mechanically rechargeable zinc-air secondary batteries, but zinc-air secondary batteries that are not of the mechanically rechargeable type and hydrogen-air secondary batteries using a hydrogen storage alloy as a negative electrode are being developed. For these secondary batteries, the reactions that occur at the negative electrode are different depending on the secondary battery, but the reactions that occur at the positive electrode (air electrode) are the same in all the secondary batteries and are represented by the reaction formulas (Chemical formula 1) and (Chemical formula 2). The inventors disclose a hydrogen-air secondary battery in U.S. Pat. No. 6,444,205.

There are many materials that have been used or considered to be used for the oxygen catalysts in not only the air electrode of the air battery but also the oxygen cathode for the brine electrolysis, the cathode of the alkaline fuel cell, and the anode for the alkaline water electrolysis. Examples of these materials include: precious metals such as platinum, silver, and gold or alloys thereof; platinum group metals, other transition metal elements, and alloys containing any of them; various oxides and sulfides; doped or non-doped carbon materials (including carbons with various crystal structures and forms such as graphite, amorphous carbon, glassy carbon, carbon nanotubes, carbon nanofibers, and fullerenes); and various nitrides, carbides, and metal organic compounds. Among these, oxides with crystal structures called pyrochlore, perovskite, and spinel structures are known as oxygen catalysts and are disclosed in, e.g., U.S. Pat. No. 6,444,205; Japanese Unexamined Patent Publication No. 2018-149518; Japanese Patent No. 5782170. The pyrochlore structure is a structure of an oxide in which the general atomic ratio of A-site element, B-site element, and oxygen in the crystal structure is A₂B₂O₇. However, not all actual pyrochlore oxides have such a ratio of integers. Especially, oxides in which the atomic ratio of oxygen is less than 7 are referred to as oxygen-deficient pyrochlore oxides, and oxides in which the atomic ratio of oxygen is larger than 7 are referred to as oxygen-excess pyrochlore oxides.

With the intension that, among such pyrochlore oxides, bismuth ruthenium oxide (hereinafter referred to as BRO) with bismuth (Bi) located at the A-sites and ruthenium (Ru) located at the B-sites would have high catalytic activity for oxygen reduction and oxygen generation as an oxygen catalyst and that other elements would be substituted for a part of the metal elements of the bismuth ruthenium oxide, the inventors synthesized pyrochlore oxides containing aluminum (Al), gallium (Ga), thallium (Tl), or lead (Pb) as well as Bi and Ru by using aqueous solutions obtained by adding a salt of Al, Ga, Tl, or Pb to an aqueous solution having salts of bismuth and ruthenium dissolved during synthesis by a coprecipitation method. The inventors evaluated the oxygen reduction characteristics of the obtained pyrochlore oxides and compared the evaluation results with BRO. The inventors disclosed in Chinami Iketani, Kenji Kawaguchi, and Masatsugu Morimitsu, Proceedings of the 59th Battery Symposium in Japan, p. 408 (2018) the findings such as that the pyrochlore oxides containing any of the above elements had a larger Tafel slope for oxygen reduction and lower catalytic activity than BRO. As used herein, the Tafel slope is the amount of change in potential required to increase the reaction current by 10 times for various electrochemical reactions in addition to oxygen reduction and oxygen generation and is usually expressed in V/dec or mV/dec (dec stands for a decade that means a factor of 10). For the oxides disclosed in Chinami Iketani, Kenji Kawaguchi, and Masatsugu Morimitsu, Proceedings of the 59th Battery Symposium in Japan, p. 408 (2018), each of aluminum bismuth ruthenium oxide (hereinafter abbreviated to as ABRO) obtained by adding Al to BRO, gallium bismuth ruthenium oxide (hereinafter abbreviated as GBRO) obtained by adding Ga to BRO, thallium bismuth ruthenium oxide (hereinafter abbreviated as TBRO) obtained by adding Tl to BRO, and lead bismuth ruthenium oxide (hereinafter abbreviated as PBRO) obtained by adding Pb to BRO had a larger Tafel slope for the oxygen reduction reaction than −43 mV/dec that is the Tafel slope of BRO. The Tafel slope takes a positive value for the oxidation reaction and a negative value for the reduction reaction. In either case, a smaller absolute value of the Tafel slope is described as a lower overvoltage, and a smaller absolute value of the Tafel slope means a higher catalytic activity. Hereinafter, the magnitude of the Tafel slope means the absolute value of the Tafel slope.

The oxidation and reduction reactions of oxygen are known as electrochemical reactions with a large Tafel slope and thus a large overvoltage. The overvoltage is the difference between the equilibrium potential in the reaction of interest and the potential at which the oxidation or reduction reaction current flows. The overvoltage takes a positive value for the oxidation reaction and a negative value for the reduction reaction. For both the oxidation reaction and the reduction reaction, the larger the absolute value of the overvoltage, the less likely the reaction to occur. Hereinafter, for simplicity, the magnitude of the overvoltage refers to the absolute value of the overvoltage. An electrochemical reaction with a large overvoltage requires a catalyst for accelerating the reaction, and it is desirable that the catalyst have a smaller Tafel slope. The Tafel slope of BRO for oxygen reduction, which is −43 mV/dec, is one of the smallest values among such various oxygen catalysts as described above, but an oxygen catalyst having an even smaller Tafel slope, particularly a Tafel slope smaller than −40 mV/dec, is desired. However, oxygen catalysts having such a small Tafel slope, namely oxygen catalysts having higher catalytic activity than BRO, have not been obtained. The exchange current density is a factor that determines the catalytic activity along with the Tafel slope. The exchange current density is generally defined as the exchange current divided by the area (as used herein, the area refers to the electrode area, the catalyst area, the electrochemically determined reaction area, etc.), and the exchange current refers to currents for the oxidation and reduction reactions in equilibrium. Since the reactions are in equilibrium, the absolute values of these currents are the same. The sign of the oxidation current is positive, and the sign of the reduction current is negative. Even when the Tafel slope is the same, the current density for oxidation or reduction that flows at the same overvoltage increases as the exchange current density increases. This is the relationship generally given by the Butler-Volmer equation. That is, in order to improve the catalytic activity of the oxygen catalyst, it is necessary to reduce the Tafel slope, or increase the exchange current density, or both. However, oxygen catalysts having a Tafel slope for oxygen reduction smaller than −40 mV/dec, particularly oxygen catalysts having a smaller Tafel slope than the pyrochlore oxides such as BRO that are very stable even in a high concentration aqueous solution and that have higher catalytic activity than various compounds such as other metals, alloys, oxides, and sulfides, have not been developed. Oxygen catalysts having a higher exchange current density than BRO having high catalytic activity have also not been developed.

Moreover, there is no electrode having higher catalytic activity, a lower overvoltage, and higher stability and durability to oxygen reduction or oxygen generation or both using an alkaline aqueous solution as an electrolyte than the electrodes using an oxygen catalyst such as BRO.

### BRIEF SUMMARY

As described above, a lower overvoltage for oxygen reduction or oxygen generation is desired for oxygen catalysts using an alkaline aqueous solution as an electrolyte. However, there are neither oxygen catalysts having a Tafel slope for oxygen reduction smaller than −40 mV/dec, or a higher exchange current density than BRO, or both, and thus having very high catalytic activity and having high chemical and electrochemical stability in an alkaline aqueous solution, nor electrodes using such an oxygen catalyst. There is also no electrode having higher catalytic activity, a lower overvoltage, and higher stability and durability to oxygen reduction or oxygen generation or both using an alkaline aqueous solution as an electrolyte than the electrodes using an oxygen catalyst such as BRO.

In order to solve the above problems, an oxygen catalyst of the present invention has the following configuration.

The oxygen catalyst of the present invention is an oxygen catalyst that uses an alkaline aqueous solution as an electrolyte. The oxygen catalyst is characterized by having a structure of a pyrochlore oxide with bismuth located at A-sites and ruthenium at B-sites, and containing manganese as well as bismuth and ruthenium. With this configuration, since the oxygen catalyst is an oxide based on a pyrochlore structure composed of bismuth, ruthenium, and oxygen. The oxygen catalyst therefore has high chemical resistance to a high concentration alkaline aqueous solution and high electrochemical resistance to oxygen reduction and oxygen generation. Since the pyrochlore structure contains manganese as well as bismuth and ruthenium, the oxygen catalyst has either a Tafel slope for oxygen reduction that is smaller than −40 mV/dec or a higher exchange current density than BRO. The oxygen catalyst therefore has a higher current density for oxygen reduction with a lower overvoltage than BRO, and thus has high specific activity. At the same time, the oxygen catalyst has catalytic activity for oxygen generation that is equal to that of BRO. The oxygen catalyst thus has improved catalytic activity for oxygen reduction while maintaining high specific activity for oxygen generation. As will be described later, the specific activity is the magnitude of current per unit area of the electrode, per unit charged ampere-hour of the catalyst, or per unit weight of the catalyst. The larger the unit area of the electrode, the unit charged ampere-hour of the catalyst, and the unit weight of the catalyst, the higher the specific activity, namely the higher the catalytic activity.

A mechanism on how the oxygen catalyst that is a pyrochlore oxide and that contains manganese as well as bismuth and ruthenium has a smaller Tafel slope and a higher exchange current density is not clear. However, it is presumed that, as manganese occupies a part of the B-sites occupied by ruthenium in BRO, the electronic state of the reaction sites where oxygen reduction occurs changes and the rate-determining step of the oxygen reduction reaction that proceeds in multiple reaction steps is shifted to a later reaction step, and therefore the Tafel slope is reduced. It is theoretically known that the Tafel slope of the electrochemical reaction varies depending on the reaction step that serves as the rate-determining step as described above, and that in the electrochemical reaction that proceeds in multiple reaction steps, the later the reaction step that serves as the rate-determining step, the smaller the Tafel slope. It is also presumed that, as manganese occupies a part of the B-sites, this results in an increased number of reaction sites on the oxide and therefore an increased exchange current density.

As can be seen from examples that will be described later, the oxygen catalyst of the present invention is obtained as a pyrochlore oxide by: preparing an aqueous solution in which metal salts of bismuth, ruthenium, and manganese, such as metal nitrates or metal chlorides of bismuth, ruthenium, and manganese, are dissolved; adding an alkaline aqueous solution to the prepared aqueous solution to precipitate hydroxides containing these metals; and baking the precipitate at a predetermined temperature. Such a production method is called a coprecipitation method. In the coprecipitation method, the optimal baking temperature for achieving the highest catalytic activity may vary depending on the type and concentration of the metal salt used in the coprecipitation method. However, in order to synthesize the catalyst of the present invention, the baking temperature is suitably in the range of 300° C. to 800° C. Baking temperatures below 300° C. are not suitable because the structural change from the state of hydroxide to oxide may not sufficiently occur and the pyrochlore oxide may not be obtained. Baking temperatures above 800° C. are also not suitable because the pyrochlore oxide may be decomposed or the composition ratio of the metals in the synthesized compound may be significantly different from the pyrochlore oxide. The baking temperatures in the range of 500° C. to 600° C. are suitable for producing the oxygen catalyst of the present invention by the coprecipitation method using metal nitrates or metal chlorides of bismuth, ruthenium, and manganese. Production of the oxygen catalyst of the present invention is not limited to the coprecipitation method, and various manufacturing methods can be used such as: a sol-gel method in which precursors like hydroxides containing metal ions are baked to produce oxides as in the coprecipitation method; methods such as a hydrothermal synthesis method; and a method in which oxides of metals are prepared in advance and a pyrochlore oxide is produced from these oxides using a solid phase reaction, a semi-solid phase reaction, etc. in addition to energy such as mechanical or thermal energy.

Examples of the alkaline aqueous solution include, but not limited to, a lithium hydroxide aqueous solution, a potassium hydroxide aqueous solution, and a sodium hydroxide aqueous solution. The pH of the alkaline aqueous solution is typically 10 or more, and the concentration suitable for such a pH is selected. When the pH is less than 10, the activity of hydroxide ions in the aqueous solution decreases, and the overvoltage for oxygen reduction and oxygen generation increases. At the same time, the conductivity of the alkaline aqueous solution decreases, which causes an increase in electrolyte resistance and electrode reaction resistance in the battery and electrolysis. The pHs of less than 10 are therefore not suitable.

The oxygen catalyst of the present invention is characterized by containing sodium. The oxygen catalyst of the present invention is also characterized in that sodium is less than 15 atom %, more suitably 11 atom % to 14 atom %, in an atomic ratio of four components that are bismuth, ruthenium, manganese. As will be described later, the results of structural analysis of the oxygen catalyst of the present invention showed that sodium is contained in the pyrochlore structure and the inter-atomic distance of sodium does not exactly match but is close to the theoretical inter-atomic distance of sodium located at the A-sites or B-sites. It was therefore found that sodium is likely to be located at the A-sites or the B-sites or both. Sodium as well as bismuth located the A-sites and ruthenium located at the B-sites are cations in the pyrochlore structure, and oxide ions that are anions, bismuth ions, ruthenium ions, manganese ions, and sodium ions that are cations are considered to balance charges in the entire oxide (this is typically the same as the total number of cations being the same as the total number of anions, but as can be seen from the results that will be described later, the oxygen catalyst of the present invention is not necessarily based on the assumption that the total number of cations being the same as the total number of anions, because the oxygen catalyst of the present invention may be of an oxygen-deficient type). Since bismuth ions, ruthenium ions, and manganese ions have different ionic radii, sodium ions are considered to adjust the strain in the structure resulting from substituting manganese ions for a part of ruthenium ions. Based on these, sodium is considered to contribute to development of high catalytic activity and structural, chemical, and electrochemical stabilization in the oxygen catalyst of the present invention containing manganese. The coprecipitation method is suitable for synthesis of the oxygen catalyst of the present invention characterized by containing sodium. Whether sodium is contained in the oxygen catalyst depends greatly on the production method of the oxygen catalyst. In particular, in order to synthesize a pyrochlore oxide with sodium located at the A-sites or the B-sites or both, a process is required in which a hydroxide containing a plurality of metals is precipitated by the coprecipitation method and a precursor containing sodium as well as bismuth, ruthenium, and manganese is obtained in the production method so that sodium is contained in the oxygen catalyst.

The oxygen catalyst of the present invention is characterized in that manganese is located at the B-sites. Since manganese is located at the B-sites, the oxygen catalyst of the present invention has a structure of BRO with manganese substituted for a part of ruthenium. Accordingly, higher catalytic activity than BRO can be achieved, and at the same time, the usage of ruthenium can be reduced as compared to BRO. That is, higher catalytic activity can be obtained with a smaller amount of ruthenium. The oxygen catalyst of the present invention is also characterized in that a composition ratio of manganese is 15 atom % or less. The oxygen catalyst of the present invention is also characterized in that manganese is cations having a valence of +4. This atom % refers to the atomic ratio of three elements, namely bismuth, ruthenium, and manganese. For example, the pyrochlore oxide containing 15 atom % of manganese is a pyrochlore oxide in which the atomic ratio of bismuth:ruthenium:manganese is 50:35:15. Such an atomic ratio of manganese is suitably less than 20 atom %. When the atomic ratio of manganese is too high, the resultant compound may be a manganese oxide as given by, e.g., the chemical formula of NaMnO₂. This is a different compound from the pyrochlore oxide and therefore does not have high catalytic activity. Moreover, manganese oxides having compositions and structures other than those of this manganese oxide may be produced as by-products and the catalyst activity may therefore become lower than BRO. Accordingly, too high atomic ratios of manganese are not suitable. Since manganese has a valence of +4, manganese can be substituted for a part of ruthenium that is a B-site element rather than an A-site element and can be located at the B-sites.

The oxygen catalyst of the present invention is characterized by being of an oxygen-deficient type. Regarding the oxygen catalyst of the present invention, being of the oxygen-deficient type means that the oxygen ratio is less than 7. In the oxygen-deficient type oxygen catalyst, oxygen-deficient sites on the oxide surface more tend to serve as oxygen adsorption sites as compared to an oxygen-excess type oxygen catalyst. Oxygen reduction starts with adsorption of oxygen on the oxygen catalyst surface. Accordingly, the catalytic activity can be improved as the oxygen-deficient sites accelerate oxygen adsorption.

An electrode of the present invention is characterized by using the oxygen catalyst of the present invention described above. The electrode of the present invention is also characterized in that the electrode is an air electrode of an air primary battery, an air electrode of an air secondary battery, an oxygen cathode for brine electrolysis, a cathode of an alkaline fuel cell, or an anode for alkaline water electrolysis.

The oxygen catalyst of the present invention and the electrode using the oxygen catalyst has a reduced Tafel slope for an oxygen reduction reaction using an alkaline aqueous solution as an electrolyte or an increased exchange current density for oxygen generation and oxygen reduction, and therefore has improved catalytic activity for oxygen reduction with a reduced overvoltage. Accordingly, the air electrode of the air battery, oxygen cathode for brine electrolysis, and cathode of the alkaline fuel cell using this oxygen catalyst have a reduced oxygen overvoltage, the air primary battery has an increased discharge voltage, the air secondary battery has an increased discharge voltage and a reduced charging voltage, the brine electrolysis requires a reduced electrolysis voltage, and the alkaline fuel cell has an increased voltage. The increase in discharge voltage of the air secondary battery improves the energy density and output density of the air battery, and the increase in discharge voltage and reduction in charging voltage of the air secondary battery improves the energy density, output density, voltage efficiency, and energy efficiency. The reduction in electrolysis voltage in the brine electrolysis reduces the power intensity and energy intensity of chlorine and caustic soda that is produced. That is, the power cost for the production can be reduced. The increase in voltage of the alkaline fuel cell improves the energy density and output density.

Moreover, according to the oxygen catalyst of the present invention and the electrode using the oxygen catalyst, the raw material cost of the catalyst having high activity can be reduced as compared to an air electrode of an air battery, oxygen cathode for brine electrolysis, cathode of a fuel cell, and anode for alkaline water electrolysis that use BRO as an oxygen catalyst. This results in reduction in production cost of the air primary battery and air secondary battery, production cost of chlorine and caustic soda that are produced by the brine electrolysis, production cost of the alkaline fuel cell, and production cost of hydrogen by the alkaline water electrolysis. For example, the current price of ruthenium is 1050 yen per gram, while the current price of manganese is 1600 yen per kilogram (1.6 yen per gram). The raw material cost can thus be significantly reduced as compared to BRO.

### BRIEF DESCRIPTION OF THE FIGURES

FIG. 1 shows polarization curves for oxygen reduction of Example 1, Comparative Example 1, Comparative Example 2, and Comparative Example 3.

FIG. 2 shows polarization curves for oxygen reduction of Comparative Example 1 and Examples 2 to 6.

FIG. 3 shows polarization curves for oxygen generation of Comparative Example 1 and Examples 2 to 6.

FIG. 4 is a graph showing the relationship between the atomic ratio of manganese and the exchange current density.

### DETAILED DESCRIPTION OF VARIOUS EMBODIMENTS

The present invention will be specifically described below based on examples. The present invention is not limited to these examples.

### Example 1

500 mL of solution was prepared by dissolving tetra-n-propylammonium bromide (dispersant), ruthenium(III) chloride hydrate, bismuth(III) nitrate hydrate, and manganese(II) nitrate hydrate in 75° C. distilled water. The ruthenium concentration was 7.44×10⁻³ mol/L and the dispersant concentration was 3.72×10⁻² mol/L. The total concentration of bismuth and manganese was also 7.44×10⁻³ mol/L that is the same as the ruthenium concentration, and the atomic ratio of bismuth to manganese was 90:10. That is, the atomic ratio of manganese, bismuth, and ruthenium was 5:45:50. After the solution was sufficiently stirred, 60 mL of 2 mol/L NaOH aqueous solution was dropped to the solution, and the resultant solution was stirred at 75° C. for 24 hours while blowing oxygen into the solution. After the stirring was stopped, the solution was left stand for 24 hours. The supernatant liquid was then removed, and the remaining precipitate was heated at 85° C. for about 2 hours to form a paste. The paste was dried at 120° C. for 3 hours. After the resultant material was pulverized in a mortar, the pulverized material was heated from room temperature to 600° C. in an air atmosphere and then held at 600° C. for one hour. The baked product thus obtained was filtered by suction filtration using about 70° C. distilled water and then dried at 120° C. for 3 hours. The substance obtained by the above operation was analyzed using an X-ray diffractometer. The analysis showed that the substance was an oxygen-deficient pyrochlore oxide as the obtained results matched the diffraction data (registration numbers 01-073-9239) of Bi_{1.87}Ru₂O_{6.903} registered in the database of the International Center for Diffraction Data (ICDD). This substance was observed with a scanning electron microscope, and its particle size was analyzed by image analysis. As a result, it was found that the average particle size was 50 nm. Elemental analysis and analysis of the composition ratio were carried out using characteristic X-rays in an energy dispersive X-ray analyzer. The results showed that the atomic ratio of the three elements, namely bismuth, ruthenium, and manganese, was Bi:Ru:Mn=46.8:47.0:5.3. Characteristic X-rays of sodium were also observed, and the obtained atomic ratio of the four elements, namely bismuth, ruthenium, manganese, and sodium, was Bi:Ru:Mn:Na=40.5:41.4:4.5:13.6.

3.7 g/L MBRO particles were added to distilled water in a sample bottle, and ultrasonic dispersion was performed using an ultrasonic generator for 2 hours to obtain a suspension of the MBRO particles. After a titanium disc (diameter: 4.0 mm, height: 4.0 mm) was placed in acetone and cleaned by ultrasound, 10 μL of the above suspension was dropped onto one side of the titanium disc and naturally dried to obtain a titanium disc uniformly carrying the MBRO particles on its one side. The amount of MBRO carried on the titanium disc was 34 μg.

The titanium disc carrying the MBRO particles thereon was attached as a working electrode to a rotating electrode device. This working electrode and a platinum plate (area: 25 cm²) were immersed in a 0.1 mol/L potassium hydroxide aqueous solution in the same container. A commercially available mercury/mercury oxide electrode immersed in a 0.1 mol/L potassium hydroxide aqueous solution was also prepared in another container. These two potassium hydroxide aqueous solutions were connected by a liquid junction filled with a 0.1 mol/L potassium hydroxide aqueous solution. By using a three-electrode electrochemical cell with such a configuration, electrochemical measurement was carried out with the temperature of the aqueous solutions adjusted to 25° C. The measurement was carried out by linear sweep voltammetry using a commercially available electrochemical measurement device and electrochemical software. This is a method in which a current flowing through the working electrode is measured while changing the potential of the working electrode at a constant sweep rate. The current flowing at this time is a current generated by a reaction that occurs in the oxygen catalyst carried on the titanium disc. Since using only the titanium disc is not enough to cause oxygen reduction or oxygen generation in a wide potential range, the reaction current generated only by the oxygen catalyst can be measured by the above measurement method. Typically, a method using a carbon disc rather than a titanium disc is often used. However, since the carbon disc itself has a catalytic action to reduce oxygen, the reaction current generated only by the oxygen catalyst cannot be measured from the current measured with the carbon disc carrying the oxygen catalyst thereon.

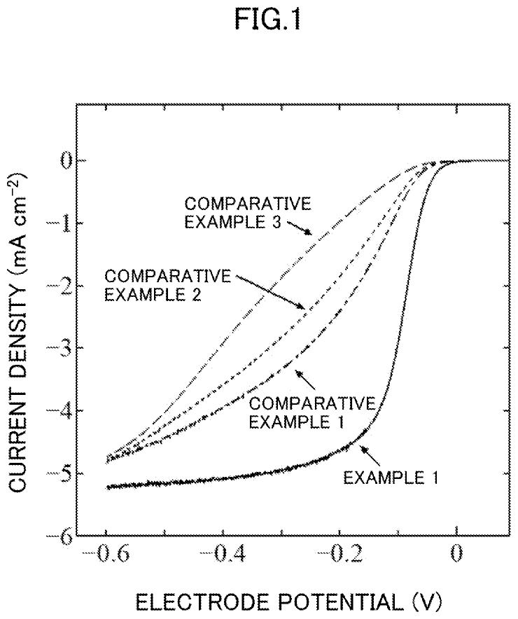

In the measurement of an oxygen reduction current, nitrogen was first blown into an aqueous solution with the working electrode immersed therein at a flow rate of 30 mL/min for 2 hours or more to remove oxygen dissolved in the aqueous solution, and then the current was measured. Thereafter, oxygen was blown into the aqueous solution at the same flow rate for 2 hours or more, and the current was measured again while continuing to blow oxygen into the aqueous solution. Subsequently, an oxygen reduction current was obtained by subtracting the current measured after blowing nitrogen from the current measured while blowing oxygen. An oxygen reduction current density was also obtained by dividing this oxygen reduction current by the surface area of the titanium disc carrying the MBRO thereon. The result showing the relationship between the potential of the working electrode and the oxygen reduction current density (hereinafter referred to as the polarization curve) was thus obtained. The working electrode used was rotated at 1600 rpm during the above measurement. Such measurement is called a rotating electrode method. The sweep rate at which the potential is changed (amount of change in electrode per second) was 1 mV/s. The obtained polarization curve was plotted according to the usual method with the abscissa representing the common logarithm of the oxygen reduction current density and the ordinate representing the potential (hereinafter this result will be referred to as the Tafel plot), and the slope of a linear part of the Tafel plot, that is, a Tafel slope, was obtained. For the results obtained as described above, the polarization curve is shown in FIG. 1, and the Tafel slope is shown in Table 1.

### Comparative Example 1

Synthesis was performed in the same manner as Example 1 except that manganese(II) nitrate hydrate was not dissolved in 75° C. distilled water and the bismuth concentration was 7.44×10⁻³ mol/L that is the same as the ruthenium concentration. The substance thus obtained was examined using an X-ray diffractometer. The examination showed that, as in Example 1, the substance was an oxygen-deficient pyrochlore oxide as the obtained results matched the diffraction data of Bi_{1.87}Ru₂O_{6.903}. This substance was observed with a scanning electron microscope, and its particle size was analyzed by image analysis. As a result, it was found that the average particle size was 28 nm. These results showed that a bismuth ruthenium oxide (BRO) with an oxygen-deficient pyrochlore structure was obtained.

The BRO particles were used to obtain a titanium disc uniformly carrying the BRO particles on its one side by the same method as Example 1. The amount of BRO carried on the titanium disc was 36 μg. A polarization curve and a Tafel slope were obtained by carrying out the same measurement as Example 1 using the titanium disc carrying the BRO particles thereon as a working electrode. The results are shown in FIG. 1 and Table 1.

### Comparative Example 2

Synthesis was performed in the same manner as Example 1 except that manganese(II) nitrate hydrate was replaced with aluminum(III) nitrate hydrate. The substance thus obtained was examined using an X-ray diffractometer. The examination showed that, as in Example 1, the substance was an oxygen-deficient pyrochlore oxide as the obtained results matched the diffraction data of Bi_{1.87}Ru₂O_{6.903}. This substance was observed with a scanning electron microscope. As a result, it was found that the average particle size was almost the same as Comparative Example 1. These results showed that an oxygen-deficient pyrochlore oxide (ABRO) containing 5 atom % of aluminum as well as bismuth and ruthenium was obtained.

The ABRO particles were used to obtain a titanium disc uniformly carrying the ABRO particles on its one side by the same method as Example 1. The amount of ABRO carried on the titanium disc was 28 μg. A polarization curve and a Tafel slope were obtained by carrying out the same measurement as Example 1 using the titanium disc carrying the ABRO particles thereon as a working electrode. The results are shown in FIG. 1 and Table 1.

### Comparative Example 3

Synthesis was performed in the same manner as Example 1 except that manganese(II) nitrate hydrate was replaced with lead(II) nitrate. The substance thus obtained was examined using an X-ray diffractometer. The examination showed that, as in Example 1, the substance was an oxygen-deficient pyrochlore oxide as the obtained results matched the diffraction data of Bi_{1.87}Ru₂O_{6.903}. A diffraction line matching the composition formula of Bi₂Ru₂O_{7.3} (registration number 00-026-0222) was also observed although the diffraction peak intensity was very low. This substance was observed with a scanning electron microscope. As a result, it was found that the average particle size was almost the same as Comparative Example 1. These results showed that an oxygen-deficient pyrochlore oxide (PBRO) containing 5 atom % of lead as well as bismuth and ruthenium was obtained.

The PBRO particles were used to obtain a titanium disc uniformly carrying the PBRO particles on its one side by the same method as Example 1. The amount of PBRO carried on the titanium disc was 35 μg. A polarization curve and a Tafel slope were obtained by carrying out the same measurement as Example 1 using the titanium disc carrying the PBRO particles thereon as a working electrode. The results are shown in FIG. 1 and Table 1.

The polarization curve in FIG. 1 shows the current density when the potential of the working electrode was changed in the negative direction at a constant rate. The current density takes a negative value for the reduction current. This means that the larger the current density in the negative direction, the larger the reduction current. When the potential is the same, the larger the reduction current, the higher the catalytic activity. When the reduction current density is the same, the higher the potential (the more on the right the potential is on the abscissa in the figure), the higher the catalytic activity. That is, it can be said that as a larger reduction current flows at a higher potential, an overvoltage for the reduction reaction is lower and therefore the catalytic activity is higher. Accordingly, the four oxygen catalysts are, in descending order of catalytic activity, Example 1, Comparative Example 1, Comparative Example 2, and Comparative Example 3. MBRO had higher catalytic activity than BRO and had higher catalyst activity than ABRO and PBO containing elements other than bismuth and ruthenium like MBRO. As described above, not all pyrochlore oxides containing elements other than bismuth and ruthenium had higher catalytic activity for oxygen reduction than BRO, and MBRO containing manganese had higher catalytic activity than BRO.

The difference in catalytic activity revealed by the polarization curves was examined by comparing the Tafel slopes. Since the Tafel slope is the amount of change in potential required to increase the current density by 10 times, the Tafel slope is a value that is not affected even if the substantial reaction surface area of the oxygen catalyst is different. It is therefore not necessary to consider the difference in amount of catalyst carried on the titanium disc when comparing the four oxygen catalysts. The smaller the Tafel slope, the more the current density increases with a lower overvoltage. That is, in the reduction current density of the polarization curve, the smaller the Tafel slope, the larger the reduction current is at the potential more on the right in the figure.

As shown in Table 1, these four oxygen catalysts are, in ascending order of the Tafel slope, MBRO, BRO, ABRO, and PBRO, and the higher the catalytic activity in the polarization curve, the smaller the Tafel slope. In particular, the Tafel slope of MBRO was −30 mV/dec that is smaller than −40 mV/dec.

TABLE 1

| | Tafel Slope (mV/dec) |
|---|---|
| Example 1 | −39 |
| Comparative Example 1 | −43 |
| Comparative Example 2 | −49 |
| Comparative Example 3 | −67 |

### Example 2

An oxygen catalyst of Example 2 was synthesized by the following method. 500 mL of solution was prepared by dissolving tetra-n-propylammonium bromide (dispersant), ruthenium(III) chloride hydrate, bismuth(III) nitrate hydrate, and manganese(II) nitrate hydrate in 75° C. distilled water. The ruthenium concentration and the manganese concentration were as shown in Table 2, and bismuth was added to the solution to the atomic ratio shown in Table 2. Bi:(Ru+Mn) shown in Table 2 represents the ratio of the bismuth concentration to the total concentration of ruthenium and manganese in the prepared solution in atom %. In Example 2, the atomic ratio of ruthenium to manganese in the prepared solution was 95:5, and the atomic ratio of bismuth, ruthenium, and manganese in the prepared solution was 48.3:49.1:2.6. After the solution was sufficiently stirred, 60 mL of 2 mol/L NaOH aqueous solution was dropped to the solution, and the resultant solution was stirred at 75° C. for 24 hours while blowing oxygen into the solution. After the stirring was stopped, the solution was left stand for 24 hours. The supernatant liquid was then removed, and the remaining precipitate was heated at 105° C. for about 2 hours to form a paste. The paste was dried at 120° C. for 3 hours. After the resultant material was pulverized in a mortar, the pulverized material was heated from room temperature to 600° C. in an air atmosphere and then held at 600° C. for one hour. The baked product thus obtained was filtered by suction filtration using about 75° C. distilled water and then dried at 120° C. for 3 hours. The substance obtained by the above operation was analyzed using an X-ray diffractometer. The analysis showed that the substance was an oxygen-deficient pyrochlore oxide as the obtained results matched the diffraction data (registration numbers 01-073-9239) of Bi_{1.87}Ru₂O_{6.903} registered in the database of the International Center for Diffraction Data (ICDD). Moreover, according to the results of energy dispersive elemental analysis, the obtained pyrochlore oxide contained sodium as well as bismuth, ruthenium, and manganese, and the atomic ratio of the three elements other than sodium and the atomic ratio of the four elements including sodium were as shown in Table 3. The results thus showed that an oxygen-deficient pyrochlore oxide containing the four elements was obtained. As described in Example 1, for the atomic ratios in Table 3, Bi:Ru:Mn is the atomic ratio of the three components, namely bismuth, ruthenium, and manganese, in atom %, and Bi:Ru:Mn:Na is the atomic ratio of the four components, namely bismuth, ruthenium, manganese, and sodium. In Table 3, the analysis results of the oxygen catalyst of Example 1 are also shown for comparison.

### Example 3

An oxygen catalyst of Example 3 was synthesized by the same oxygen catalyst synthesis method as Example 2 except that the ruthenium concentration and the manganese concentration were as in Table 2 and bismuth was added to the ratio shown in Table 2. That is, the atomic ratio of ruthenium to manganese in the prepared solution was 90:10 and the atomic ratio of bismuth, ruthenium, and manganese in the prepared solution was 50:45:5. The substance thus obtained was analyzed using an X-ray diffractometer. The analysis showed that the substance was an oxygen-deficient pyrochlore oxide as the obtained results matched the diffraction data (registration numbers 01-073-9239) of Bi_{1.87}Ru₂O_{6.903} registered in the database of the International Center for Diffraction Data (ICDD). Moreover, according to the results of energy dispersive elemental analysis, the obtained pyrochlore oxide contained sodium as well as bismuth, ruthenium, and manganese, and the atomic ratio of the three elements other than sodium and the atomic ratio of the four elements including sodium were as shown in Table 3. The results thus showed that an oxygen-deficient pyrochlore oxide containing the four elements was obtained.

### Example 4

An oxygen catalyst of Example 4 was synthesized by the same oxygen catalyst synthesis method as Example 2 except that the ruthenium concentration and the manganese concentration were as in Table 2 and bismuth was added to the molar ratio shown in Table 2. That is, the atomic ratio of ruthenium to manganese in the prepared solution was 85:15 and the atomic ratio of bismuth, ruthenium, and manganese in the prepared solution was 50:42.5:7.5. The substance thus obtained was analyzed using an X-ray diffractometer. The analysis showed that the substance was an oxygen-deficient pyrochlore oxide as the obtained results substantially matched the diffraction data (registration numbers 01-073-9239) of Bi_{1.87}Ru₂O_{6.903} registered in the database of the International Center for Diffraction Data (ICDD). However, the 20 values of the diffraction peaks of (222), (400), and (440) planes were higher by about 0.2 deg to 0.35 deg than those of the peak positions of the diffraction data in the database. This is theoretically reasonable for the following reason. Ruthenium having a valence of +4 has an ionic radius of 0.62 angstroms, while manganese having a valence of +4 has an ionic radius of 0.53 angstroms. Manganese thus has a smaller ionic radius. Accordingly, when manganese is considered to have been substituted for ruthenium located at the B-sites, the oxygen catalyst has reduced lattice spacing and diffraction peaks shifted to higher angles. Moreover, according to the results of energy dispersive elemental analysis, the obtained pyrochlore oxide contained sodium as well as bismuth, ruthenium, and manganese, and the atomic ratio of the three elements other than sodium and the atomic ratio of the four elements including sodium were as shown in Table 3. The results thus showed that an oxygen-deficient pyrochlore oxide containing the four elements was obtained.

### Example 5

An oxygen catalyst of Example 5 was synthesized by the same oxygen catalyst synthesis method as Example 2 except that the ruthenium concentration and the manganese concentration were as in Table 2 and bismuth was added to the molar ratio shown in Table 2. That is, the atomic ratio of ruthenium to manganese in the prepared solution was 80:20 and the atomic ratio of bismuth, ruthenium, and manganese in the prepared solution was 50:40:10. The substance thus obtained was analyzed using an X-ray diffractometer. The analysis showed that the substance was an oxygen-deficient pyrochlore oxide as the obtained results substantially matched the diffraction data (registration numbers 01-073-9239) of Bi_{1.87}Ru₂O_{6.903} registered in the database of the International Center for Diffraction Data (ICDD). However, the 2θ values of the diffraction peaks of (222), (400), and (440) planes were higher than those of the peak positions of the diffraction data in the database as in Example 4. Moreover, according to the results of energy dispersive elemental analysis, the obtained pyrochlore oxide contained sodium as well as bismuth, ruthenium, and manganese, and the atomic ratio of the three elements other than sodium and the atomic ratio of the four elements including sodium were as shown in Table 3. The results thus showed that an oxygen-deficient pyrochlore oxide containing the four elements was obtained.

### Example 6

An oxygen catalyst of Example 6 was synthesized by the same oxygen catalyst synthesis method as Example 2 except that the ruthenium concentration and the manganese concentration were as in Table 2 and bismuth was added to the molar ratio shown in Table 2. That is, the atomic ratio of ruthenium to manganese in the prepared solution was 70:30 and the atomic ratio of bismuth, ruthenium, and manganese in the prepared solution was 50:35:15. The substance thus obtained was analyzed using an X-ray diffractometer. The analysis showed that the substance was an oxygen-deficient pyrochlore oxide as the obtained results substantially matched the diffraction data (registration numbers 01-073-9239) of Bi_{1.87}Ru₂O_{6.903} registered in the database of the International Center for Diffraction Data (ICDD). However, the 2θ values of the diffraction peaks of (222), (400), and (440) planes were higher than those of the peak positions of the diffraction data in the database as in Example 4. Moreover, according to the results of energy dispersive elemental analysis, the obtained pyrochlore oxide contained sodium as well as bismuth, ruthenium, and manganese, and the atomic ratio of the three elements other than sodium and the atomic ratio of the four elements including sodium were as shown in Table 3. The results thus showed that an oxygen-deficient pyrochlore oxide containing the four elements was obtained.

TABLE 2

| | Ruthenium | Bismuth | |
|---|---|---|---|
| | Concentration | Concentration | Bi:(Ru + Mn) |
| | (mol/L) | (mol/L) | (atom %) |
| Example 2 | 3.53 × 10⁻³ | 1.86 × 10⁻⁴ | 48.3:51.7 |
| Example 3 | 3.35 × 10⁻³ | 3.72 × 10⁻⁴ | 48.3:51.7 |
| Example 4 | 3.16 × 10⁻³ | 5.58 × 10⁻⁴ | 50:50 |
| Example 5 | 2.98 × 10⁻³ | 7.44 × 10⁻⁴ | 50:50 |
| Example 6 | 2.60 × 10⁻³ | 1.12 × 10⁻³ | 50:50 |

TABLE 3

| | Bi:Ru:Mn | Bi:Ru:Mn:Na |
|---|---|---|
| | (atom %) | (atom %) |
| Example 1 | 46.8:47.9:5.3 | 40.5:41.4:4.5:13.6 |
| Example 2 | 49.7:47.9:2.5 | 43.1:41.5:2.1:13.3 |
| Example 3 | 49.5:45.3:5.2 | 43.7:39.9:4.6:11.8 |
| Example 4 | 50.5:42.1:7.4 | 44.6:37.1:6.6:11.7 |
| Example 5 | 50.7:39.7:9.6 | 44.1:34.4:8.4:13.1 |
| Example 6 | 50.5:36.0:13.5 | 44.4:31.7:11.9:12.0 |

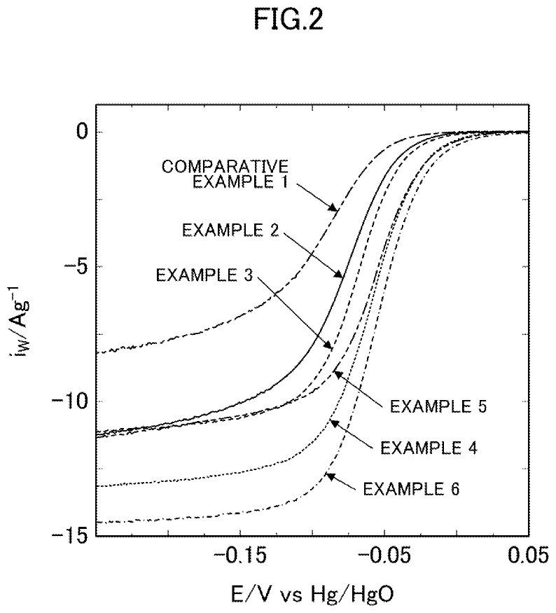

For each of the oxygen catalysts of Examples 2 to 6, a titanium disc carrying the MBRO particles thereon was obtained by a method similar to Example 1. By using each of the titanium discs carrying the MBRO particles thereon, linear sweep voltammetry was performed by the same method as Example 1 to measure a polarization curve for oxygen reduction. A polarization curve for oxygen generation was also measured by linear sweep voltammetry at the same sweep rate as the measurement of polarization for oxygen reduction. In addition to these measurements, cyclic voltammetry was also performed at 5 mV/s to measure a charging current of an electrical double layer, and the charged ampere-hour Cp (unit: C/cm²) of the electrical double layer was obtained from the measurement result of the charging current. A Tafel slope was also obtained by the same method as Example 1 from the results of the linear sweep voltammetry, and the exchange current density was obtained from the intersection of the Tafel plot. The relationship between the specific activity iw that is the oxygen reduction current divided by the weight of the catalyst carried on the titanium disc and the potential was obtained from the relationship between the potential and the oxygen reduction current obtained by the linear sweep voltammetry. The results are shown in FIG. 2. The specific activity iw was used instead of the oxygen reduction current for the following reason. The oxygen reduction reaction occurs at the three-phase boundary where the catalyst, the alkaline aqueous solution, and oxygen contact each other. Accordingly, when the amount of catalyst carried is large, the three-phase boundary is also large. In order to compare the catalysts with different element composition ratios, it is therefore suitable to perform normalization using the amount of catalyst carried. The result for the oxygen catalyst of Comparative Example 1 is also shown in FIG. 2 for comparison. According to the results of FIG. 2, each of the oxygen catalysts MBRO of Examples 2 to 6 containing manganese generated an oxygen reduction current from a higher potential (potential more on the right in the figure) and had a larger maximum value of specific activity shown in FIG. 2 as compared to the oxygen catalyst BRO of Comparative Example 1 that does not contain manganese. That is, MBRO had higher catalytic activity for oxygen reduction than BRO. Moreover, comparison of Examples 2 to 6 shows that, like Example 6, as the atomic ratio of manganese increased, the oxygen reduction current flowed from a higher potential, and the maximum value of specific activity tended to be larger. It was therefore found that the high atomic ratio of manganese improved the oxygen activity for oxygen reduction.

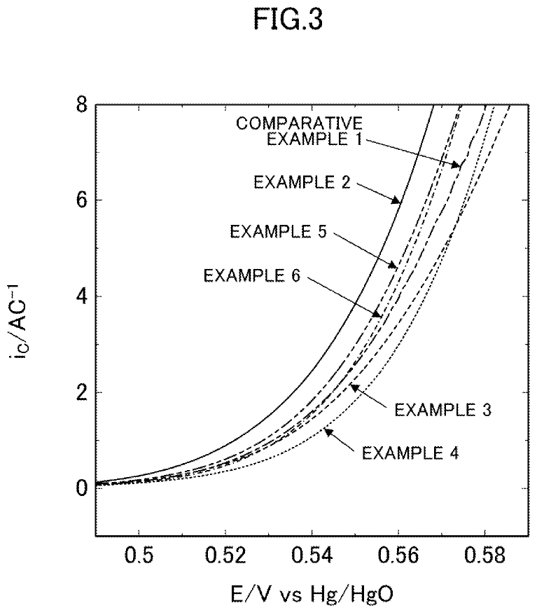

The relationship between the specific activity ic that is the oxygen generation current divided by the charged ampere-hour of the electrical double layer and the potential was obtained from the relationship between the potential and the oxygen generation current obtained by the linear sweep voltammetry. The results are shown in FIG. 3. The specific activity ic was used instead of the oxygen generation current for the following reason. It is known that an oxygen generation reaction occurs at the two-phase boundary where the catalyst and the alkaline aqueous solution contacts each other and that the surface area of the two-phase boundary that functions for oxygen generation (hereinafter referred to as the reaction surface area) is proportional to the charged ampere-hour of the electrical double layer. It is also possible to compare the catalysts based on the specific activity iw that is the amount of catalyst carried divided by the current. However, by using the specific activity ic, the catalysts can be compared based on the difference in catalytic activity that reflects the difference in particle size of the catalyst. Accordingly, in order to consider the activity in view of the reaction surface area that depends on the two-phase boundary, the specific activity ic is more suitable than the specific activity iw. The result for the oxygen catalyst of Comparative Example 1 is also shown in FIG. 3 for comparison. According to the results of FIG. 3, for the oxygen catalyst BRO of Comparative Example 1 that does not contain manganese and the oxygen catalysts MBRO of Examples 2 to 6 containing manganese, the potential at the maximum specific activity value 8 A/C in the figure was 0.568 V in Example 2 in which the oxygen generation current flowed at the lowest potential, that is, the overvoltage was the lowest, 0.580 V in Comparative Example 1, and 0.585 V in Example 4 in which the overvoltage was the highest. That is, the difference between Example 2 with the lowest overvoltage and Example 4 with the highest overvoltage was 0.017 V, and the differences between Comparative Example 1 and Example 2 and between Comparative Example 1 and Example 4 were smaller than this value. The differences between Comparative Example 1 and Examples 2 to 6 were thus smaller than the differences in catalytic activity for oxygen reduction shown in FIG. 3. That is, it was found from the results of the examples in the present invention that the oxygen catalysts of the present invention exhibit substantially the same properties as BRO for oxygen generation.

The Tafel slopes for oxygen reduction and oxygen generation were obtained from the slopes of the Tafel plots of Examples 2 to 6. The results are shown in FIG. Table 4. In this table, Example 2 had the smallest Tafel slope for oxygen reduction. As the atomic ratio of manganese increased from Example 2 to Example 6, the Tafel slope increased accordingly. The Tafel slope for oxygen generation did not have such a fixed tendency for the atomic ratio of manganese, and was in the range from a minimum value of 38 mV/dec to at most 41 mV/dec. The Tafel slope for oxygen reduction of Comparative Example 1 was −43 mV/dec as shown in Table 1, but the Tafel slope for oxygen generation of Comparative Example 1 was 40 mV/dec.

TABLE 4

| | Tafel Slope for | Tafel Slope for |
|---|---|---|
| | Oxygen Reduction | Oxygen Generation |
| | (mV/dec) | (mV/dec) |
| Example 2 | −39 | 39 |
| Example 3 | −41 | 41 |
| Example 4 | −43 | 38 |
| Example 5 | −44 | 38 |
| Example 6 | −47 | 41 |

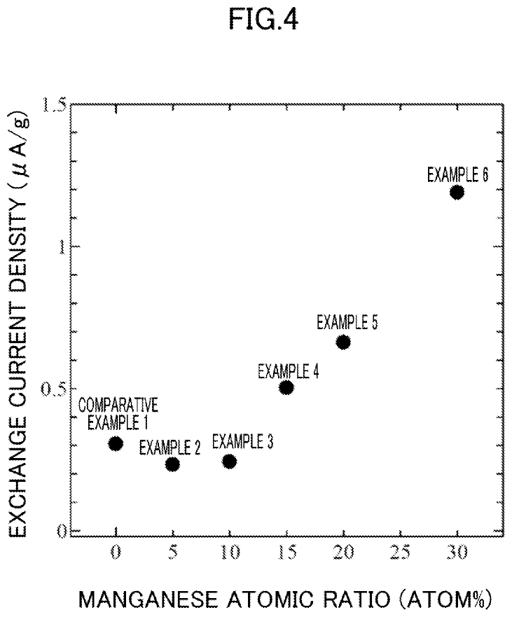

The exchange current was obtained from the intersection of the Tafel plot, and a value i0 (unit: μA/g) that is the exchange current divided by the amount of catalyst carried on the titanium disc and the average of the values i0 were calculated. The results for Comparative Example 1 and Examples 2 to 6 are shown in FIG. 4. The atomic ratio of manganese on the abscissa of the figure is zero for Comparative Example 1 as Comparative Example 1 does not contain manganese. For Examples 2 to 6, the atomic ratio of manganese is shown based on the atomic ratio of two components, namely ruthenium and manganese, in the solution during synthesis of the catalyst. The smaller the Tafel slope and the larger the exchange current density, the higher the catalytic activity. According to the results of FIG. 4, as the atomic ratio of manganese increases, the exchange current density increases. The exchange current density increases particularly at an atomic ratio higher than 15 atom %, and the exchange current density of Example 6 is about four times that of Comparative Example 1. Based on these results together with the results of the Tafel slope, the Tafel slope for oxygen reduction tends to increase as the atomic ratio of manganese increases. However, the increase in exchange current density more dominantly affects the catalytic activity than this increase in Tafel slope does. This shows that the catalytic activity for oxygen reduction of Examples 2 to 6 dramatically improved over Comparative Example 1. It was thus found that manganese can not only reduce the Tafel slope but also increase the exchange current density.

### Comparative Example 4

An oxygen catalyst of Comparative Example 4 was synthesized by the same oxygen catalyst synthesis method as Example 2 except that the atomic ratio of Bi:(Ru+Mn) was 50:50 and the atomic ratio of Ru:Mn was 60:40 with the atomic ratio of Mu relatively higher than Example 6. That is, the atomic ratio of ruthenium to manganese in the prepared solution was 60:40 and the atomic ratio of bismuth, ruthenium, and manganese in the prepared solution was 50:30:20. The substance thus obtained was analyzed using an X-ray diffractometer. The analysis showed that not only an oxygen-deficient pyrochlore oxide was synthesized as a large number of diffraction peaks different from the diffraction data (registration number 01-073-9239) of Bi_{1.87}Ru₂O_{6.903} registered in the database of the International Center for Diffraction Data (ICDD) were observed in addition to diffraction peaks substantially matching the diffraction data. That is, the results showed that a compound containing a byproduct was obtained in addition to a pyrochlore oxide due to the high atomic ratio of manganese to bismuth or ruthenium used for the synthesis.

(EXAFS Structural Analysis)

For the oxygen catalysts of Examples 2 and 3, an X-ray absorption fine structure (EXAFS) spectrum was measured, and information regarding the valences and structures of bismuth, ruthenium, manganese, and sodium was obtained from the X-ray absorption near edge structure (commonly called XANES) in the spectrum. Information regarding the local structure of the oxygen catalyst (atomic species neighboring a certain atom, valence, and inter-atomic distance) was also obtained from the extended X-ray absorption fine structure (commonly called EXAFS) appearing in the region from about 100 eV or more above the absorption edge in the spectrum.

The results for both Example 2 and Example 3 showed that bismuth was cations having a valence of +3 and located at the A-sites of the pyrochlore structure, ruthenium was cations having a valence of +4 and located at the B-sites of the pyrochlore structure, and manganese was cations having a valence of +4 and located at the B-sites of the pyrochlore structure. The results also showed that sodium is cations having a valence of +1 and is likely to be located at both A-sites and B-sites.

### CONCLUSION

The oxygen catalyst of the present invention can be used not only in air electrodes of an air primary battery and an air secondary battery, an oxygen cathode for brine electrolysis, a cathode of an alkaline fuel cell, and an anode for alkaline water electrolysis, but also as a catalyst for oxygen generation or oxygen reduction or both in a battery, electrolyzer, and sensor that use oxygen reduction or oxygen generation or both by using an alkaline aqueous solution as an electrolyte. The electrode of the present invention can be used not only as air electrodes of an air primary battery and an air secondary battery, an oxygen cathode for brine electrolysis, a cathode of an alkaline fuel cell, and an anode for alkaline water electrolysis but also as a positive electrode, negative electrode, anode, or cathode in a battery, electrolyzer, and sensor that use oxygen reduction or oxygen generation or both as an electrode reaction by using an alkaline aqueous solution as an electrolyte.

1-10. (canceled)

11. An oxygen catalyst that uses an alkaline aqueous solution as an electrolyte, the oxygen catalyst comprising a structure of a pyrochlore oxide with bismuth located at A-sites and ruthenium at B-sites, and containing manganese as well as the bismuth and the ruthenium.

12. The oxygen catalyst of claim 11, wherein the pyrochlore oxide further contains sodium.

13. The oxygen catalyst of claim 12, wherein the sodium is less than 15 atom % in an atomic ratio of four elements that are the bismuth, the ruthenium, the manganese, and the sodium.

14. The oxygen catalyst of claim 13, wherein the sodium is 11 atom % to 14 atom % in the atomic ratio of the four elements that are the bismuth, the ruthenium, the manganese, and the sodium.

15. The oxygen catalyst of claim 11, wherein the manganese is located at the B sites.

16. The oxygen catalyst of claim 12, wherein the manganese is located at the B sites.

17. The oxygen catalyst of claim 13, wherein the manganese is located at the B sites.

18. The oxygen catalyst of claim 11, wherein the manganese is 15 atom % or less in an atomic ratio of three elements that are the bismuth, the ruthenium, and the manganese.

19. The oxygen catalyst of claim 13, wherein the manganese is 15 atom % or less in an atomic ratio of three elements that are the bismuth, the ruthenium, and the manganese.

20. The oxygen catalyst of claim 15, wherein the manganese is 15 atom % or less in an atomic ratio of three elements that are the bismuth, the ruthenium, and the manganese.

21. The oxygen catalyst of claim 11, wherein the manganese is cations having a valence of +4.

22. The oxygen catalyst of claim 13, wherein the manganese is cations having a valence of +4.

23. The oxygen catalyst of claim 15, wherein the manganese is cations having a valence of +4.

24. The oxygen catalyst of claim 18, wherein the manganese is cations having a valence of +4.

25. The oxygen catalyst of claim 11, wherein the pyrochlore oxide is of an oxygen-deficient type.

26. The oxygen catalyst of claim 15, wherein the pyrochlore oxide is of an oxygen-deficient type.

27. The oxygen catalyst of claim 18, wherein the pyrochlore oxide is of an oxygen-deficient type.

28. The oxygen catalyst of claim 22, wherein the pyrochlore oxide is of an oxygen-deficient type.

29. An electrode characterized by using the oxygen catalyst of claim 11.

30. The electrode of claim 29, wherein the electrode is one of: an air electrode of an air primary battery, an air electrode of an air secondary battery, an oxygen cathode for brine electrolysis, a cathode of an alkaline fuel cell, or an anode for alkaline water electrolysis.
